(19) United States
(12) Patent Application Publication
(10) Pub. No.: US 2015/0029648 A1
(43) Pub. Date: Jan. 29, 2015

(54) WINDOW PANEL, MANUFACTURING METHOD THEREOF, AND DISPLAY APPARATUS INCLUDING THE WINDOW PANEL

(71) Applicant: SAMSUNG DISPLAY CO., LTD., Yongin-City (KR)

(72) Inventor: Hun-Kyo Kim, Yongin-City (KR)

(73) Assignee: SAMSUNG DISPLAY CO., LTD., Yongin-City (KR)

(21) Appl. No.: 14/102,408

(22) Filed: Dec. 10, 2013

(30) Foreign Application Priority Data
Jul. 26, 2013 (KR) 10-2013-0088977

(51) Int. Cl. G06F 1/16; B32B 27/28; B32B 27/08; B29C 65/70; B29C 65/00

(52) U.S. Cl. CPC G06F 1/1637; B29C 65/70; B29C 66/45; B32B 27/08; B32B 27/28; B29K 2069/00
USPC 361/679.3; 264/261; 428/412

(57) ABSTRACT

A window panel includes an adhesion-base layer having first and second surfaces opposite to each other and including a thermoplastic polymer, a first film on the first surface and including a first plastic layer and a first surface hardness layer on the first plastic layer, and a second film on the second surface and including a second plastic layer and a second surface hardness layer on the second plastic layer. The adhesion-base layer, the first plastic layer, and the second plastic layer include a same material. A display apparatus includes the window panel. A method of manufacturing the window panel includes preparing the first film, preparing the second film, disposing the first film and the second film parallel to each other, providing a thermoplastic polymer between the first film and the second film, and forming the adhesion-base layer by curing the thermoplastic polymer.

### CROSS-REFERENCE TO RELATED APPLICATION

This application claims priority to and the benefit of Korean Patent Application No. 10-2013-0088977, filed on Jul. 26, 2013 in the Korean Intellectual Property Office, the entire content of which is incorporated herein by reference.

### BACKGROUND

1. Technical Field

One or more embodiments of the present invention relate to a window panel, a manufacturing method thereof, and a display apparatus including the window panel.

2. Description of the Related Art

The sizes of apparatuses including display panels (such as mobile phones or tablet computers) have increased due to the inclusion of touch panels. Tempered glass may be used as a window panel for protecting the surface of a display. However, since tempered glass may be broken by external impact, tempered glass may not be safe. Also, the specific gravity of tempered glass is about 2.5, and thus, it may be disadvantageous to use tempered glass in lightweight electronic devices.

A plastic material may be used as the window panel and may have a structure in which a plurality of stacked layers in order to provide strength. Since light emitted from a display panel must be visible by a user, one important characteristic of the window panel is its optical properties. However, the window panel having the plurality of stacked layers may have deteriorated optical properties.

### SUMMARY

One or more embodiments of the present invention include a window panel, a manufacturing method thereof, and a display apparatus including the window panel.

Additional aspects will be set forth in part in the description which follows and, in part, will be apparent from the description, or may be learned by practice of the presented embodiments.

According to one or more embodiments of the present invention, a window panel includes: an adhesion-base layer having a first surface and a second surface opposite to the first surface and including a thermoplastic polymer; a first film disposed on the first surface of the adhesion-base layer and including a first plastic layer and a first surface hardness layer on the first plastic layer; and a second film disposed on the second surface of the adhesion-base layer and including a second plastic layer and a second surface hardness layer on the second plastic layer. The adhesion-base layer, the first plastic layer, and the second plastic layer include the same material.

The first plastic layer of the first film may be in direct contact with the first surface of the adhesion-base layer, and the second plastic layer of the second film may be in direct contact with the second surface of the adhesion-base layer.

The first film and the second film may be coupled to each other using the adhesion-base layer as an adhesive medium.

The adhesion-base layer may be cured between the first film and the second film.

The adhesion-base layer, the first plastic layer, and the second plastic layer may be formed of polycarbonate.

The first surface hardness layer of the first film, and the second surface hardness of the second film may each be formed of silsesquioxane.

The light transmittance of the window panel may be equal to or greater than about 89%.

The yellowness index of the window panel may be less than about 1.0.

According to one or more embodiments of the present invention, a display apparatus includes a display panel, and a transparent window panel for protecting the display panel disposed on a light exit plane of the display panel. The transparent window panel includes: an adhesion-base layer having a first surface and a second surface opposite to the first surface and including a thermoplastic polymer; a first film on the first surface of the adhesion-base layer and including a first plastic layer and a first surface hardness layer on the first plastic layer; and a second film on the second surface of the adhesion-base layer and including a second plastic layer and a second surface hardness layer on the second plastic layer. The adhesion-base layer, the first plastic layer, and the second plastic layer include the same material.

The first film and the second film may be integrally coupled to the adhesion-base layer as the adhesion-base layer is cured.

To couple the first and second films to the adhesion-base layer, the first plastic layer of the first film may be in direct contact with the first surface of the adhesion-base layer, and the second plastic layer of the second film may be in direct contact with the second surface of the adhesion-base layer.

The adhesion-base layer, the first plastic layer, and the second plastic layer may be formed of polycarbonate.

The light transmittance of the transparent window panel may be equal to or greater than about 89%.

The yellowness index of the transparent window panel may be less than about 1.0.

The yellowness index of the transparent window panel may be about 0.6 or less.

The first film may further include a first intermediate layer between the first plastic layer and the first surface hardness layer, and the second film may further include a second intermediate layer between the second plastic layer and the second surface hardness layer.

According to one or more embodiments of the present invention, a method of manufacturing a window panel includes: preparing a first film including a first plastic layer and a first surface hardness layer on the first plastic layer; preparing a second film including a second plastic layer and a second surface hardness layer on the second plastic layer; disposing the first film and the second film parallel to each other; providing a thermoplastic polymer made of the same material as the first plastic layer and the second plastic layer between the first film and the second film; and forming an adhesion-base layer by curing (e.g., by cooling) the thermoplastic polymer.

Disposing the first film and the second film parallel to each other may include disposing the first and second films such that the first plastic layer of the first film and the second plastic layer of the second film face each other.

Providing the thermoplastic polymer may include providing a thermoplastic polymer at a temperature of about 300° C. or higher between the first plastic layer and the second plastic layer.

The first plastic layer, the second plastic layer, and the thermoplastic polymer may each be formed of polycarbonate.

The first surface hardness layer and the second surface hardness may each be formed of silsesquioxane.

### BRIEF DESCRIPTION OF THE DRAWINGS

These and/or other aspects will become apparent and more readily appreciated from the following description of the embodiments when considered in conjunction with the accompanying drawings, in which:

FIG. 1 is a schematic perspective view of a display apparatus according to an embodiment of the present invention;

FIG. 2 is an exploded out perspective view of the window panel and the display panel of the display apparatus of FIG. 1;

FIG. 3 is a partial cross-sectional view of a window panel according to an embodiment of the present invention;

FIGS. 4A and 4B are cross-sectional views of the window of FIG. 3 at different stages in a manufacturing process according to an embodiment of the present invention;

FIG. 5 is a cross-sectional view of a window panel according to another embodiment of the present invention; and

FIG. 6 is a cross-sectional view of a window panel prepared according to the comparative examples.

### DETAILED DESCRIPTION

Reference will now be made to certain embodiments, examples of which are illustrated in the accompanying drawings, where like reference numerals refer to like elements throughout. The presented embodiments may be modified in different ways and should not be construed as limited to the descriptions set forth herein. Accordingly, the embodiments are described below for illustrative purposes, by reference to the figures, to explain certain aspects of the present description.

While the described embodiments of the invention may be modified in various ways, the described embodiments are presented as examples in the drawings and in the detailed description below. The intention, however, is not to limit the invention to the particular embodiments described. On the contrary, the invention is intended to cover all modifications, equivalents, and alternatives falling within the scope of the invention as defined by the appended claims. Moreover, detailed descriptions related to well-known functions or configurations have been omitted in order not to unnecessarily obscure the subject matter of the present invention.

It will be understood that although the terms “first”, “second”, etc. may be used herein to describe various components, these components should not be limited by these terms. These descriptors are only used to distinguish one component from another. The terminology in this application is used to more clearly describe the presented embodiments and is not intended to limit the scope of the present invention.

As used herein, the singular forms “a”, “an”, and “the” are intended to include the plural forms as well, unless the context clearly indicates otherwise. It will be further understood that the terms “comprises” and/or “comprising,” as used herein, specify the presence of the stated features or components, but do not preclude the presence or addition of one or more other features or components. “/,” as used in herein may be interpreted as “and,” or may be interpreted as “or” depending on the situation.

The sizes of the layers and regions in the drawings may be exaggerated for convenience of explanation. Like reference numerals refer to like elements throughout. It will be understood that when a layer, region, or component is referred to as being “on” or “formed on,” another layer, region, or component, it can be directly or indirectly on or formed on the other layer, region, or component. That is, for example, intervening layers, regions, or components may be present.

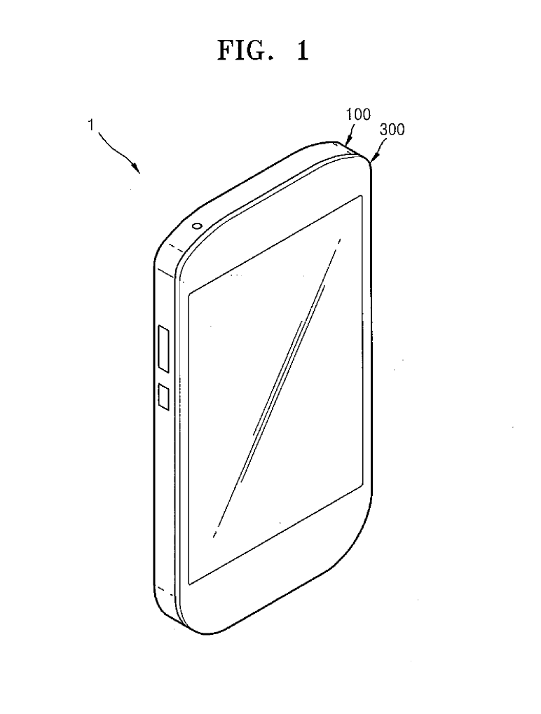

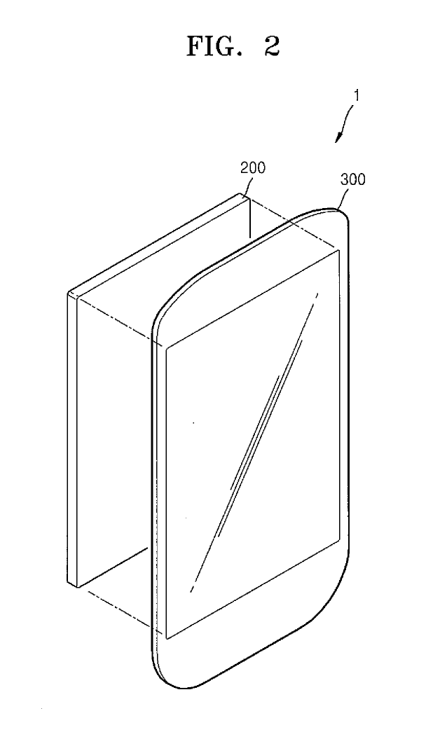

FIG. 1 is a schematic perspective view of a display apparatus 1 according to an embodiment of the present invention, and FIG. 2 is an exploded perspective view of the display apparatus of FIG. 1 showing a window panel 300 and a display panel 200 of the display apparatus 1. Referring to FIGS. 1 and 2, the display apparatus 1 may include a housing 100 having at least one open surface. The display panel 200 is accommodated in the housing 100, and the window panel 300 is disposed on a light exit plane of the display panel 200. The display apparatus 1 may be a portable electronic device, such as a mobile phone or tablet computer. However, the display apparatus 1 is not limited thereto. In another embodiment, the display apparatus 1 may be a relatively large-sized electronic device, such as a monitor or TV.

The housing 100 has a structure in which at least one surface is open, and the open surface may be covered by the window panel 300. The display panel 200 and the parts required for driving the display panel 200 may be mounted in the housing 100.

The display panel 200 may be an organic light-emitting display panel. In another embodiment, the display panel 200 may be a liquid crystal panel, a plasma display panel, a field-emission display panel, or an electrophoretic display panel.

The window panel 300 is disposed on the light exit plane of the display panel 200 to protect the display panel 200. The window panel 300 has transparent characteristics so that a user can see the light emitted from the display panel 200. Unlike tempered glass, the window panel 200 according to an embodiment of the present invention may effectively protect the display panel 200 from external impact or contaminants, and may be lightweight.

Hereinafter, the window panel 300 according to embodiments of the present invention will be described.

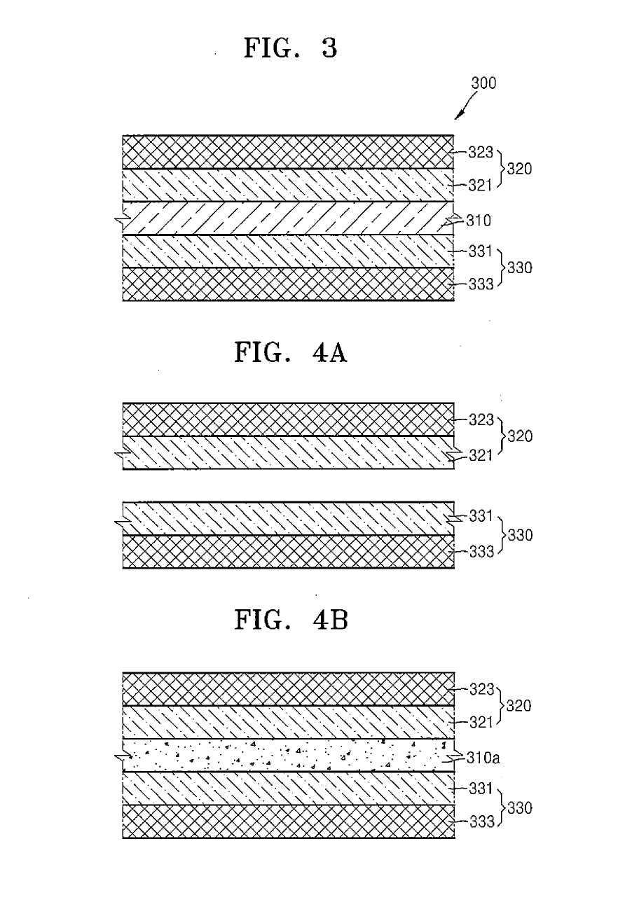

FIG. 3 is a partial cross-sectional view of a window panel 300 according to an embodiment of the present invention, and FIGS. 4A and 4B are cross-sectional views of the window panel 300 of FIG. 3 at different stages in a manufacturing process of the window panel.

Referring to FIG. 3, the window panel 300 may include an adhesion-base layer 310, a first film 320, and a second film 330. The first film 320 and the second film 330 may be formed symmetrically about the adhesion-base layer 310 in order to prevent curling of the window panel 300.

The adhesion-base layer 310 may couple the first film 320 on a first surface of the adhesion-base layer 310 to the second film 330 on a second surface (opposite to the first surface) of the adhesion-base layer 310. The adhesion-base layer 310 may also provide stiffness/rigidity to the window panel 300.

The first film 320 may include a first plastic layer 321 and a first surface hardness layer 323, and the second film 330 may include a second plastic layer 331 and a second surface hardness layer 333. The first plastic layer 321 is coupled or bonded to the adhesion-base layer 310 while being in direct contact with the first surface of the adhesion-base layer 310. The second plastic layer 331 is coupled or bonded to the adhesion-base layer 310 while being in direct contact with the second surface of the adhesion-base layer 310.

The adhesion-base layer 310 may be formed by curing a thermoplastic polymer 310a (such as polycarbonate) during the manufacture of the window panel 330. Referring to FIGS. 4A and 4B, the first and second films 320 and 330 are disposed in parallel such the first plastic layer 321 and the second plastic layer 331 face each other. A thermoplastic polymer 310a at a temperature of about 300° C. or higher is provided between the first and second plastic layers 321 and 331. Then, the window panel 300 may be manufactured by curing the thermoplastic polymer 310a. The cured thermoplastic polymer 310a becomes the adhesion-base layer 310.

Portions of the first and second plastic layers 321 and 331, for example, the surfaces of the first and second plastic layers 321 and 331 that face each other, may partially melt due to contact with the thermoplastic polymer 310a at the temperature of about 300° C. or higher provided between the first and second plastic layers 321 and 331. The partially melted first and second plastic layers 321 and 331 then cool, which effects the coupling or bonding of the first and second plastic layers 321 and 331 to the high-temperature thermoplastic polymer 310a. That is, curing of the high-temperature thermoplastic polymer 310a simultaneously forms the adhesion-base layer 310 and couples or bonds the first and second plastic layers 321 and 331 to the adhesion-base layer 310.

The first and second plastic layers 321 and 331 may include the same material (e.g., polycarbonate) as the adhesion-base layer 310. When the first and second plastic layers 321 and 331 and the adhesion-base layer 310 include the same material, a binder is not needed to couple or bond the adhesion-base layer 310 to the first and second plastic layers 321 and 331 during curing of the thermoplastic polymer 310a at a temperature of about 300° C. or higher is cured since the coupling (or bonding) occurs between layers of the same material.

If the first and second plastic layers 321 and 331 and the adhesion-base layer 310 are formed of different materials, a binder may be used to improve or ensure adhesion between the layers. In such an embodiment, a printing process may be used to coat the binder, and the light transmittance and yellowness index (YI) of the window panel 300 may be somewhat decreased due to the presence of the binder. However, according to an embodiment of the present invention, the first and second plastic layers 321 and 331 and the adhesion-base layer 310 are formed of the same material, and the adhesion-base layer 310 is coupled or bonded to the first and second plastic layers 321 and 331 during curing of the adhesion-base layer 310. As such, an adhesive, such as a binder, is not necessary, thereby generally preventing the decrease in light transmittance and YI of the window panel 300.

According to embodiments of the present invention, the window panel 300 is formed without an adhesive (such as the binder), and may have good optical properties, including a light transmittance of about 89% or higher and a YI of less than about 1.0. The optical properties of the window panel 300 are described in more detail below.

According to an embodiment, the adhesion-base layer 310 and the first and second plastic layers 321 and 331 may be formed of polycarbonate. A reliability test may be performed on the window panel 300. The reliability test may be performed according to a method in which the window panel 300 is exposed for about 120 hours at a temperature of about 80° C. and a humidity of about 85%. When polycarbonate is used, the window panel 300 is not deformed. However, when materials other than polycarbonate (for example, materials such as polyethylene terephthalate (PET) and polymethyl methacrylate (PMMA)) are used, the window panel 300 may deform. The results of a reliability test are described in more detail below.

The first hardness layer 323 and the second hardness layer 333 may be formed of silsesquioxane, which has good impact resistance and anti-fingerprint characteristics as well as high surface hardness.

In an embodiment, the first and second films 320 and 330 include the first and second plastic layers 321 and 331 and the first and second surface hardness layers 323 and 333, respectively. However, the present invention is not limited thereto.

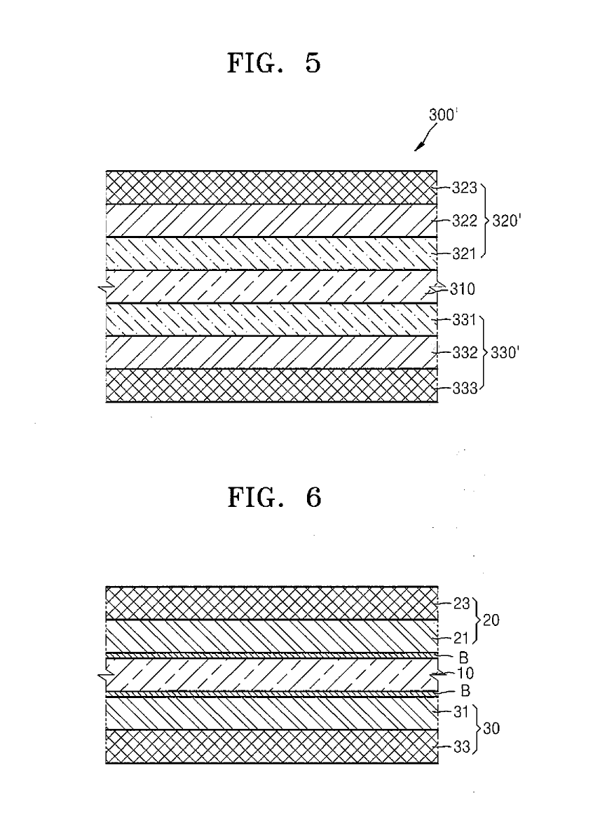

If desired, as illustrated in FIG. 5, the first film 320′ of the window panel 300′ may further include a first intermediate layer 322 between the first plastic layer 321 and the first surface hardness layer 323, and the second film 330′ may further include a second intermediate layer 332 between the second plastic layer 331 and the second surface hardness layer 333. The first and second intermediate layers 322 and 332 may include a material, such as PMMA.

### Optical Property Tests

Hereinafter, results of optical property tests conducted on certain examples and comparative examples will be described. However, it will be understood that the examples and comparative examples are presented for illustrative purposes only, and do not limit the scope of the present invention.

FIG. 6 is a cross-sectional view of a window panel according to the comparative examples described below. The window panel according to each of the comparative examples includes a base layer 10, first and second films 20 and 30 disposed on opposite sides of the base layer 10 and including first and second plastic layers 21 and 31 and first and second surface hardness layers 23 and 33. The first and second plastic layers 21 and 31 and the base layer 10 are formed of different materials, and separate binder layers B are included to promote bonding of those layers.

### Example 1

A window panel was constructed with the structure illustrated in FIG. 3. Specifically, the first and second films 320 and 330 were each prepared by stacking a silsesquioxane layer having a thickness of about 100 μm as the first or second hardness layer 323 or 333, and a polycarbonate layer having a thickness of about 100 μm as the first or second plastic layer 321 and 331. The first and second films 320 and 330 were disposed in parallel such that the polycarbonate layer of the first film 320 and the polycarbonate layer of the second film 330 faced each other. Thereafter, polycarbonate at a temperature of about 380° C. was provided between the first and second films 320 and 330 and cured, thus preparing a window panel including an adhesion-base layer 310 having a thickness of about 400 μm.

Table 1 lists the light transmittance, Yellowness Index (YI), and haze for each of three samples (A-1, A-2 and A-3) of the window panel prepared according to Example 1.

TABLE 1

| Embodiment 1 | Transmittance | YI | Haze |
|---|---|---|---|
| Sample A-1 | 89.99 | 0.54 | 0.9 |
| Sample A-2 | 90.03 | 0.56 | 0.7 |
| Sample A-3 | 89.60 | 0.75 | 0.6 |

### Example 2

A window panel was constructed with the structure illustrated in FIG. 5. Specifically, the first and second films 320′ and 330′ were each prepared by stacking a silsesquioxane layer having a thickness of about 100 μm as the first or second hardness layer 323 or 333, a PMMA layer having a thickness of about 75 μm as the first or second intermediate layer 322 or 332, and a polycarbonate layer having a thickness of about 25 μm as the first or second plastic layer 321 or 331. The first and second films 320′ and 330′ were disposed in parallel such that the polycarbonate layer of the first film 320′ and the polycarbonate layer of the second film 330′ faced each other. Thereafter, polycarbonate at a temperature of about 380° C. was provided between the first and second films 320′ and 330′ and cured, thus preparing a window panel including an adhesion-base layer 310 having a thickness of about 400 μm.

Table 2 lists the light transmittance, YI, and haze for each of three samples (B-1, B-2 and B-3) of the window panel prepared according to Example 2.

TABLE 2

| Embodiment 2 | Transmittance | YI | Haze |
|---|---|---|---|
| Sample B-1 | 89.25 | 0.72 | 0.7 |
| Sample B-2 | 89.09 | 0.83 | 0.8 |
| Sample B-3 | 90.01 | 0.69 | 0.6 |

### Comparative Example 1

A window panel was constructed with the structure illustrated in FIG. 6. Specifically, the first and second films 20 and 30 were each prepared by stacking a silsesquioxane layer having a thickness of about 100 μm as the first or second hardness layer 23 or 33, and a polyethylene terephthalate (PET) layer having a thickness of about 100 μm as the first or second plastic layer 21 or 31. A binder layer B was printed on each of the PET layer of the first film 20 and the PET layer of the second film 30. Thereafter, the first and second films 20 and 30 were disposed in parallel, and polycarbonate at a temperature of about 380° C. was provided between the first and second films 20 and 30 and cured. Thus, a window panel including a base layer 10 having a thickness of about 400 μm was manufactured.

Table 3 lists the light transmittance, YI, and haze for each of three samples (C-1, C-2 and C-3) of the window panel prepared according to Comparative Example 1.

TABLE 3

| Comparative | | | |
|---|---|---|---|
| Example 1 | Transmittance | YI | Haze |
| Sample C-1 | 88.15 | 1.92 | 0.8 |
| Sample C-2 | 88.06 | 2.01 | 0.9 |
| Sample C-3 | 87.99 | 2.08 | 0.9 |

### Comparative Example 2

A window panel was constructed with the structure illustrated in FIG. 6. Specifically, the window panel was manufactured as in Comparative Example 1 except that PMMA layers having thicknesses of about 100 μm were used as the first and second films instead of the PET layers.

Table 4 lists the light transmittance, YI, and haze for each of three samples (D-1, D-2 and D-3) of the window panel prepared according to Comparative Example 2.

TABLE 4

| Comparative | | | |
|---|---|---|---|
| Example 2 | Transmittance | YI | Haze |
| Sample D-1 | 88.33 | 2.02 | 1 |
| Sample D-2 | 88.03 | 1.98 | 0.9 |
| Sample D-3 | 87.85 | 2.12 | 1.1 |

Referring to FIGS. 1 to 4, each of the window panels prepared according to Examples 1 and 2 (i.e., the window panels formed without an adhesive, such as a binder) exhibited a light transmittance of about 89% or higher. In contrast, each of the window panels prepared according to Comparative Examples 1 and 2 exhibited a light transmittance of about 87% or about 88%.

Also, each of the window panels prepared according to Example 1 had a YI value of about 0.75 or lower, and each of the window panels prepared according to Example 2 had a YI value of about 0.9 or lower. In contrast, each of the window panels according to Comparative Examples 1 and 2 had a YI value of about 1.9 or higher.

### Reliability Test

Hereinafter, results of reliability tests conducted on examples and comparative examples will be described. However, it is understood that the examples and comparative examples are presented for illustrative purposes only, and do not limit the scope of the present invention. The window panel according to Example 3 (which was used in the reliability test) used polycarbonate as the adhesion-base layer, as in the above-described Example 1. In contrast, the window panels according to Comparative Examples 3 to 5 respectively used PMMA (Comparative Example 3), a synthetic material of PMMA and rubber (Comparative Example 4), and a synthetic material of polycarbonate and PMMA (Comparative Example 5) as the adhesion-base layer. The reliability tests were performed according to a method in which the window panels were exposed for about 120 hours to a temperature of about 80° C. and a humidity of about 85%.

The results of the reliability tests conducted on Example 3 and Comparative Examples 3-5 are presented in Table 5 below.

TABLE 5

| | | | Com- | |
|---|---|---|---|---|
| | | Com- | parative | Comparative |
| | | parative | Example 5 | Example 6 |
| | Embodiment 3 | Example 4 | (PMMA + | (polycarbonate + |
| | (polycarbonate) | (PMMA) | rubber) | PMMA) |
| Results | No deformation | Deformed | Deformed | Deformed |
| (presence of | | | | |
| deformation) | | | | |

Referring to Table 5, the window panel using polycarbonate as the adhesion-base layer exhibited no deformation. However, all of the window panels prepared according to the comparative examples exhibited deformation.

As described above, one or more embodiments of the present invention are directed to a lightweight window panel having good optical properties, and a display apparatus including the same.

Since a binder is not necessary during the manufacturing of the window panel, the manufacturing process may be simplified.

It should be understood that the exemplary embodiments described herein should be considered in a descriptive sense only, and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes may be made to the described embodiments without departing from the spirit and scope of the present invention as defined by the following claims.

What is claimed is:

1. A window panel comprising:
an adhesion-base layer having a first surface and a second surface opposite to the first surface, the adhesion-base layer comprising a thermoplastic polymer;
a first film on the first surface of the adhesion-base layer, the first film comprising a first plastic layer and a first surface hardness layer on the first plastic layer; and
a second film on the second surface of the adhesion-base layer, the second film comprising a second plastic layer and a second surface hardness layer on the second plastic layer,
wherein the adhesion-base layer, the first plastic layer, and the second plastic layer include a same material.

2. The window panel of claim 1, wherein the first plastic layer of the first film is in direct contact with the first surface of the adhesion-base layer, and the second plastic layer of the second film is in direct contact with the second surface of the adhesion-base layer.

3. The window panel of claim 1, wherein the first film and the second film are coupled to each other by the adhesion-base layer.

4. The window panel of claim 1, wherein the adhesion-base layer is cured between the first film and the second film.

5. The window panel of claim 1, wherein the adhesion-base layer, the first plastic layer, and the second plastic layer are each formed of polycarbonate.

6. The window panel of claim 1, wherein the first surface hardness layer of the first film and the second surface hardness layer of the second film are each formed of silsesquioxane.

7. The window panel of claim 1, wherein a light transmittance of the window panel is equal to or greater than about 89%.

8. The window panel of claim 1, wherein a yellowness index of the window panel is lower than about 1.0.

9. A display apparatus comprising:
a display panel; and
a transparent window panel on a light exit plane of the display panel,
wherein the transparent window panel comprises:
an adhesion-base layer having a first surface and a second surface opposite to the first surface, the adhesion-base layer comprising a thermoplastic polymer;
a first film on the first surface of the adhesion-base layer, the first film comprising a first plastic layer and a first surface hardness layer on the first plastic layer; and
a second film on the second surface of the adhesion-base layer, the second film comprising a second plastic layer and a second surface hardness layer on the second plastic layer,
wherein the adhesion-base layer, the first plastic layer, and the second plastic layer include a same material.

10. The display apparatus of claim 9, wherein the first film and the second film are integrally coupled to the adhesion-base layer as the adhesion-base layer is cured.

11. The display apparatus of claim 9, wherein the first plastic layer of the first film is in direct contact with the first surface of the adhesion-base layer, and the second plastic layer of the second film is in direct contact with the second surface of the adhesion-base layer.

12. The display apparatus of claim 9, wherein the adhesion-base layer, the first plastic layer, and the second plastic layer are each formed of polycarbonate.

13. The display apparatus of claim 9, wherein a light transmittance of the transparent window panel is equal to or greater than about 89%.

14. The display apparatus of claim 9, wherein a yellowness index of the transparent window panel is lower than about 1.0.

15. The display apparatus of claim 9, wherein the first film further comprises a first intermediate layer between the first plastic layer and the first surface hardness layer, and the second film further comprises a second intermediate layer between the second plastic layer and the second surface hardness layer.

16. A method of manufacturing a window panel, the method comprising:
preparing a first film comprising a first plastic layer and a first surface hardness layer on the first plastic layer;
preparing a second film comprising a second plastic layer and a second surface hardness layer on the second plastic layer;
disposing the first film and the second film parallel to each other;
providing a thermoplastic polymer of a same material as the first plastic layer and the second plastic layer between the first film and the second film; and
forming an adhesion-base layer by curing the thermoplastic polymer.

17. The method of claim 16, wherein the disposing the first film and the second film parallel to each other comprises disposing the first and second films such that the first plastic layer of the first film and the second plastic layer of the second film face each other.

18. The method of claim 17, wherein the providing the thermoplastic polymer comprises providing a thermoplastic polymer at a temperature of about 300° C. or higher between the first plastic layer and the second plastic layer.

19. The method of claim 16, wherein the first plastic layer, the second plastic layer, and the thermoplastic polymer are each formed of polycarbonate.

20. The method of claim 16, wherein the first surface hardness layer and the second surface hardness layer are each formed of silsesquioxane.
